(19) United States
(12) Patent Application Publication
(10) Pub. No.: US 2023/0090968 A1
(43) Pub. Date: Mar. 23, 2023

(54) AIR REED INSTRUMENT

(71) Applicant: Ryou OHNO, Tokyo (JP)

(72) Inventor: Ryou OHNO, Tokyo (JP)

(21) Appl. No.: 17/759,386

(22) PCT Filed: Aug. 26, 2020
(86) PCT No.: PCT/JP2020/032259

§ 371 Date: Jul. 25, 2022

(30) Foreign Application Priority Data
Jan. 28, 2020 (JP) 2020-012067

(51) Int. Cl. G10D 7/026

(52) U.S. Cl. CPC G10D 7/026

(57) ABSTRACT

Provided is an air reed instrument that allows even those who have poor playing ability, such as beginners, to easily produce sound. An air reed instrument according to the present invention is configured such that multiple protrusions/recesses or rectifying fins are provided successively on an inner wall 3 of a blow hole 2 and an inner wall 4 of a head joint 1 over the width of the major axis of the blow hole 2 so as to be orthogonal to the longitudinal direction of the head joint 1. The protrusions/recesses or the rectifying fins act as a windway so that after the exhaled air flowing into the blow hole 2 circulates in the head joint 1, there is an increase in the proportion of the exhaled air that flows out from the mouth piece 2, making it easy to produce sound.

### FIELD OF THE INVENTION

The present invention relates to an air reed instrument that can easily produce sound.

### BACKGROUND OF THE INVENTION

Examples of air reed instruments are flutes and recorders. The flute player presses the lower lip against the lip plate to create a specific embouchure (lip shape) and blows exhaled air onto the inner wall of the blow hole to play. A flute player can produce a rich sound over a wide range by adjusting the embouchure, exhaled air, opening and closing of tone holes, and so on.

However, adjusting the embouchure depends largely on the ability of the player. For this reason, it was difficult for a person with poor playing ability, such as a beginner, to produce a flute sound.

On the other hand, the recorder is provided with a windway (a path through which exhaled air flows). Therefore, when the player of a recorder blows exhaled air from the inlet of the windway, exhaled air is ejected from the other outlet and guided to the edge, so that the sound can be easily produced.

### PRIOR ART LITERATURE

### Patent Literature

Patent Document 1: Japanese Laid-Open Patent Publication No. 1991-184089
Patent Document 2: Japanese Laid-Open Patent Publication No. 1992-011287
Patent Document 3: Japanese Laid-Open Patent Publication No. 1993-035261
Patent Document 4: Japanese Laid-Open Patent Publication No. 1993-197370
Patent Document 5: Japanese Laid-Open Patent Publication No. 1995-129152
Patent Document 6: Japanese Laid-Open Patent Publication No. 2017-68109
Patent Document 7: Japanese Laid-Open Patent Publication No. 2017-68110

### Non-Patent Literature

Non-Patent Document 1: “Acoustics of Musical Instruments,” Yoshinori Ando, 1971, Ongaku no Tomo Sha Corp.

### SUMMARY OF THE INVENTION

### Technical Problem

The problem to be solved is that it is difficult for a person with poor playing ability such as a beginner to produce the sound of an air reed instrument.

### Solution to Problem

The most important feature of the present invention is that one or more protrusions/recesses or rectifying fins are continuously provided on the inner walls of the blow hole and the head joint so as to be orthogonal to the longitudinal direction of the head joint. As a result the sound of a flute can be easily produced.

### Advantageous Effects of Invention

In the air reed instrument of the present invention, the flow of exhaled air is guided by protrusions/recesses or rectifying fins, so that sound is easily produced. In addition, this air reed instrument has the advantage that the tone and key operations are the same as those of conventional musical instruments.

### BRIEF DESCRIPTION OF THE DRAWINGS

FIG. 1 is the appearance view including a cross section of a head joint showing an embodiment of this air reed instrument.

FIG. 2 is the appearance view of a head joint showing an embodiment of this air reed instrument.

### DETAILED DESCRIPTION OF THE INVENTION

The purpose of easily producing the sound of an air reed instrument was realized by continuously providing one or more protrusions/recesses or rectifying fins on the inner walls of the blow hole and the head joint, so as to be orthogonal to the longitudinal direction of the head joint.

### Example 1

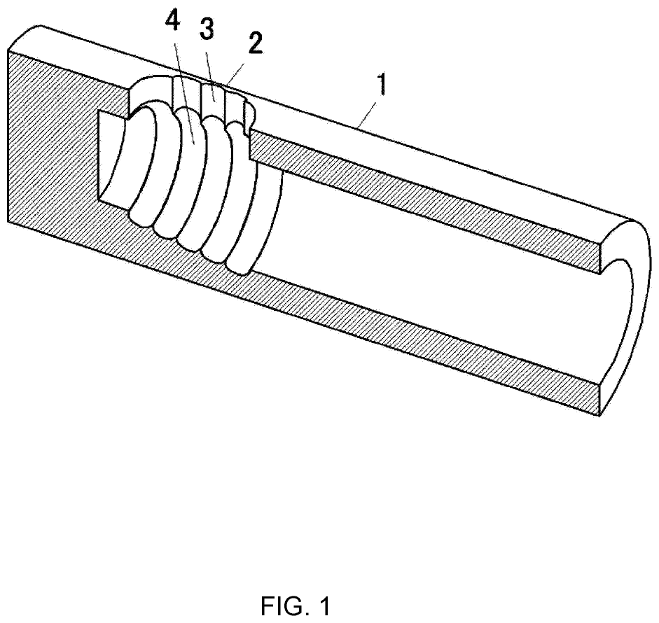

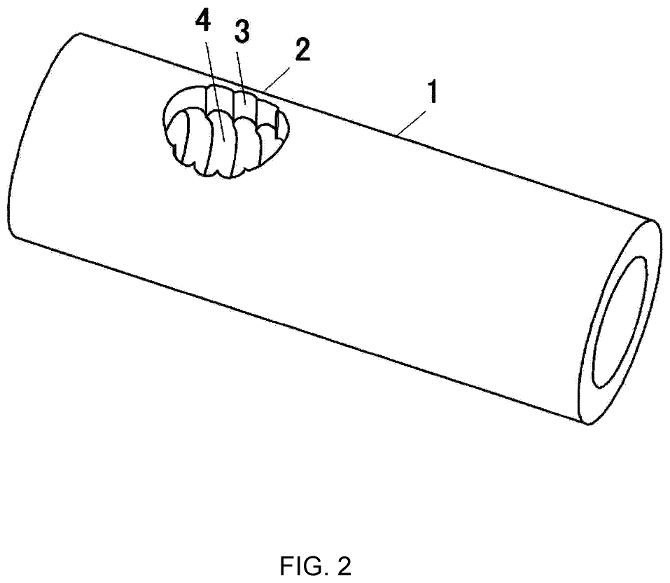

FIG. 1 is an appearance view including a cross section when the head joint of the air reed instrument of the present invention is cut at a vertical plane including a joint axis. FIG. 2 is an appearance view of the head joint.

The embodiment of the air reed instrument of the present invention has a structure in which one or more protrusions/recesses or rectifying fins are continuously provided on the inner wall 3 of the blow hole and the inner wall 4 of the head joint of a thick-walled cylindrical tube. These protrusions/recesses or fins are provided to be orthogonal to the longitudinal direction of the head joint 1. FIG. 1 shows a state when multiple semi-elliptical protrusions/recesses are provided over the same width as the major axis of the blow hole 2. In the head joint of a conventional air reed instrument, a lip plate is brazed on a riser attached on a thin-walled cylindrical tube. The head joint 1 of the present invention is a cylindrical tube having a thickness equal to the total of three pieces of the thin-walled cylindrical tube, riser, and lip plate of the conventional head joint. Its outer surface has the same height and performs the same function as a lip plate of a conventional a flute. Other than this point, it has the same structure as the conventional head joint. The same function can be obtained by providing protrusions/recesses or rectifying fins on the head joint of a conventional air reed instrument, also. Further, it is effective also to partially provide protrusions/recesses or the rectifying fins, such as providing only on the inner wall 4 of the head joint and not providing on the blow hole 3.

The role of the protrusions/recesses or rectifying fin is the same as that of the windway of a recorder. When playing an air reed instrument, the player presses his lower lip against the blow hole 2 to blow the exhaled air. The exhaled air that has flowed into the blow hole 2 is guided by the protrusions/recesses or the rectifying fins, flows around the inside of the head joint 1, and flows out from the blow hole 2. Half of the upper open end of the blow hole 2 is blocked by the lower lip, and the exhaled air flows out from the open part, along the rounded part of the lower lip. At that time, it collides with and coalesces with the exhaled air flowing into the blow hole 2, and exits from the blow hole 2 together. The higher the ratio of the amount of outflow to inflow exhaled air into the blow hole 2, the clearer the sound becomes. A person with poor playing ability, such as a beginner, has an inappropriate distance or angle when blowing exhaled air into the blow hole 2, and the exhaled air dissipates in the blow hole 2, making it difficult to produce sound. The protrusions/recesses or the rectifying fins act as a windway, and even if the exhaled air is blown somewhat inappropriately, the exhaled air is guided and flows out from the blow hole 2 to become a sound.

The exhaled air flowing into the blow hole 2 increases the air pressure in the head joint 1, and the exhaled air flowing out from the blow hole 2 lowers the air pressure. Repeating high and low of the air pressure in the head joint makes a sound. This air reed function is exhibited when the exhaled air flowing out from the blow hole 2 collides with and coalesces with the inflowing exhaled air, and when the efficiency of flowing out from the blow hole 2 is high.

### INDUSTRIAL APPLICABILITY

Air reed instruments with protrusions/recesses or rectifying fins that guide the flow of exhaled air on the inner wall of the blow hole and the inner wall of the head joint are expected to increase the use of beginners because they can easily produce sound. Also, it can be expected that the person who interrupted the air reed instrument will try to play again.

### REFERENCE NUMBERS

1: Head joint
2: Blow hole
3: Protrusions/recesses of the blow hole
4: Protrusions/recesses of the inner wall of the head joint

1. In an air reed instrument having a blow hole on the head joint:
the head joint is characterized in that one or more protrusions/recesses or rectifying fins are continuously provided on the inner wall of the head joint so as to be orthogonal to the longitudinal direction of the head joint.
